(19) United States
(12) Patent Application Publication
(10) Pub. No.: US 2016/0066039 A1
(43) Pub. Date: Mar. 3, 2016

(54) PRIVACY-PRESERVING RECOMMENDATION SYSTEM

(71) Applicants: Sandilya BHAMIDIPATI, Palo Alto, CA (US); Nadia FAWAZ, Santa Clara, CA (US); THOMSON LICENSING, Issy les Moulineaux (FR)

(72) Inventors: Sandilya Bhamidipati, Palo Alto, CA (US); Nadia Fawaz, Santa Clara, CA (US)

(21) Appl. No.: 14/786,245

(22) PCT Filed: Jun. 12, 2013
(86) PCT No.: PCT/US2013/045343

§ 371 Date: Oct. 22, 2015

(51) Int. Cl. H04N 21/466; H04N 21/25; H04N 21/81; H04N 21/2668; H04N 21/2547; G06Q 30/02; H04N 21/258

(52) U.S. Cl. CPC H04N 21/4667; G06Q 30/0269; G06Q 30/0275; G06Q 30/0242; H04N 21/252; H04N 21/25891; H04N 21/2668; H04N 21/2547; H04N 21/812

(57) ABSTRACT

A method and system of recommending content and targeting advertisements for one or more users is provided. The system includes an aggregator that is connected to the one or more users and collects rich user data therefrom. The method includes collecting rich user data from one or more users; building one or more user profiles corresponding to the one or more users; storing the one or more user profiles in a memory database; requesting one or more content profiles from one or more providers; receiving the one or more content profiles; determining whether one of the user profiles is a target user profile for one of the content profiles based on the rich user data associated with the target user profile; and delivering content programs associated with the content profiles to the target user.

### BACKGROUND

Targeted advertising and content recommendation are typically based around the collection, sharing and mining of information with respect to a potential viewer base. For example, if a person or group of people has a particular interest, then an advertiser who learns of this interest may select an appropriate advertisement to be viewed by such a person or group that would garner the most views and have the greatest likelihood of converting a viewer into a customer. In order to learn of such interests, targeted advertising and recommendation systems often request feedback from a person or group of people to learn what their interests are. Alternatively, targeted advertising and recommendation systems often monitor the activity of a viewer of a particular medium, such as television, and use associated contextual information (e.g. temporal information) to judge whether a viewer is likely or unlikely to be interested in a particular advertisement.

Unfortunately, privacy becomes an issue for users of such personalization systems. When a user learns that a particular system shares the information located in his/her user profile with a content provider or an advertiser, the user often feels that his or her privacy has been violated and is more reluctant to share any additional information about their interests. Such reluctance can stymie the effectiveness of a content recommendation and targeted advertising system, making their services appear less valuable to advertisers.

### SUMMARY

In view of the foregoing, a privacy-preserving content recommendation and targeted advertising method and system are disclosed. The system includes an aggregator that is connected to one or more users and collects rich user data therefrom. The method involves collecting rich user data from one or more users, the rich user data including content viewing habits of the one or more users; building one or more user profiles corresponding to the one or more users; storing the one or more user profiles in a memory database; requesting one or more content profiles from one or more providers; receiving the one or more content profiles; determining whether one of the one or more user profiles is a target user profile for one of the one or more content profiles based on the rich user data associated with the target user profile; and delivering one or more content programs associated with the one of the one or more content profiles to the user associated with the target user profile.

### BRIEF DESCRIPTION OF THE DRAWINGS

For a more complete understanding of the present invention, reference is made to the following detailed description of an embodiment considered in conjunction with the accompanying drawings, in which:

FIG. 1 is a diagram of content recommendation and targeted advertising system in accordance with an embodiment of the invention;

FIG. 2 is a flow chart illustrating a method of recommending content and targeting advertisements in accordance with an embodiment of the invention; and

FIG. 3 is a flow chart illustrating a method of recommending content and targeting advertisements in accordance with an embodiment of the invention.

### DETAILED DESCRIPTION

The techniques generally relate to a content recommendation and targeted advertising system that utilizes rich user data in making decisions on what content to recommend and what advertisements to deliver to a particular user. The rich user data is collected at an aggregator, which creates user profiles for multiple users using such rich user data. The user profiles are then used to recommend content and target advertisements based on whether a particular content and/or advertisement profile can be a suitable match to a particular user based on the rich user data associated with that user. During this process, the privacy of the user profiles is kept by not sharing them with content providers and/or advertisers, and/or by sharing them with content providers/advertisers under a privacy-preserving protocol.

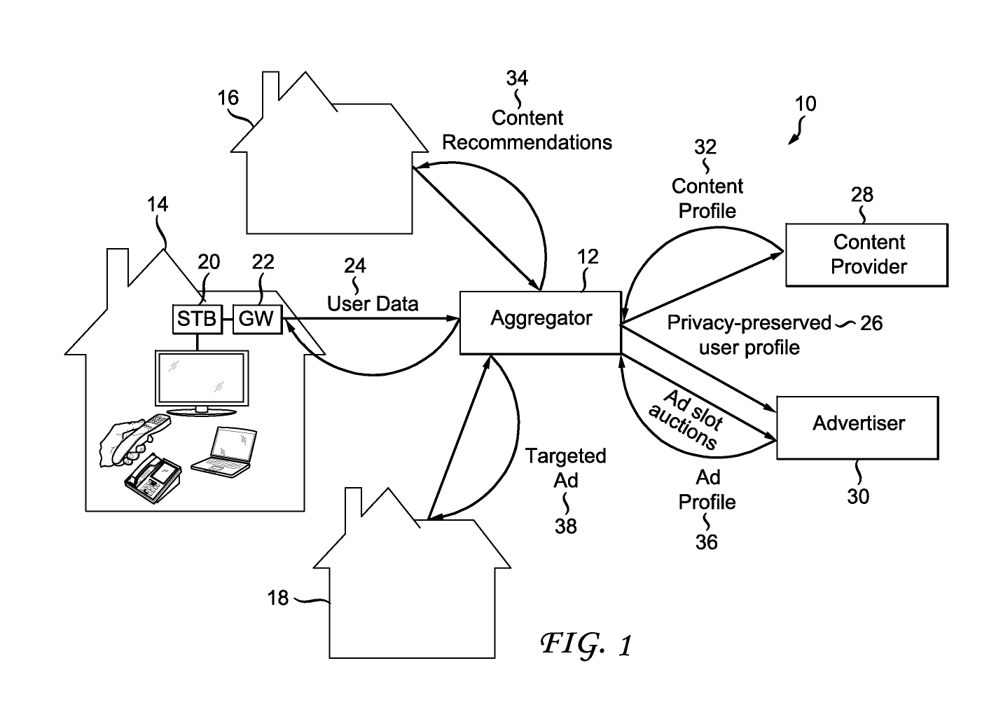

Turning to FIG. 1, a diagram of a content recommendation and targeted advertising system 10 in accordance with an embodiment is displayed. The system comprises an aggregator 12 that is connected to users 14, 16, 18 through their media consumption devices (e.g., set top box 20) via a gateway 22. The aggregator 12 gathers user data 24 from the users 14, 16, 18 and creates a user profile 26 from the user data 24 for each user 14, 16, 18. The aggregator 12 also makes connections to content providers (e.g., content provider 28) and advertisers (e.g., advertiser 30) to obtain content profiles 32 having content recommendations 34 and advertisement profiles 36 having targeted advertisements 38 based on the information contained in a user's user profile 26. The aggregator 12 can then send these content recommendations 34 and advertisements 38 to a user 14, 16, 18. The information from the user profile 26 is kept from content provider 28 and/or advertiser 30 to maintain an associated user's privacy while allowing the aggregator 12 to choose the appropriate content recommendation 34 and/or advertisement 38 to be delivered to the user.

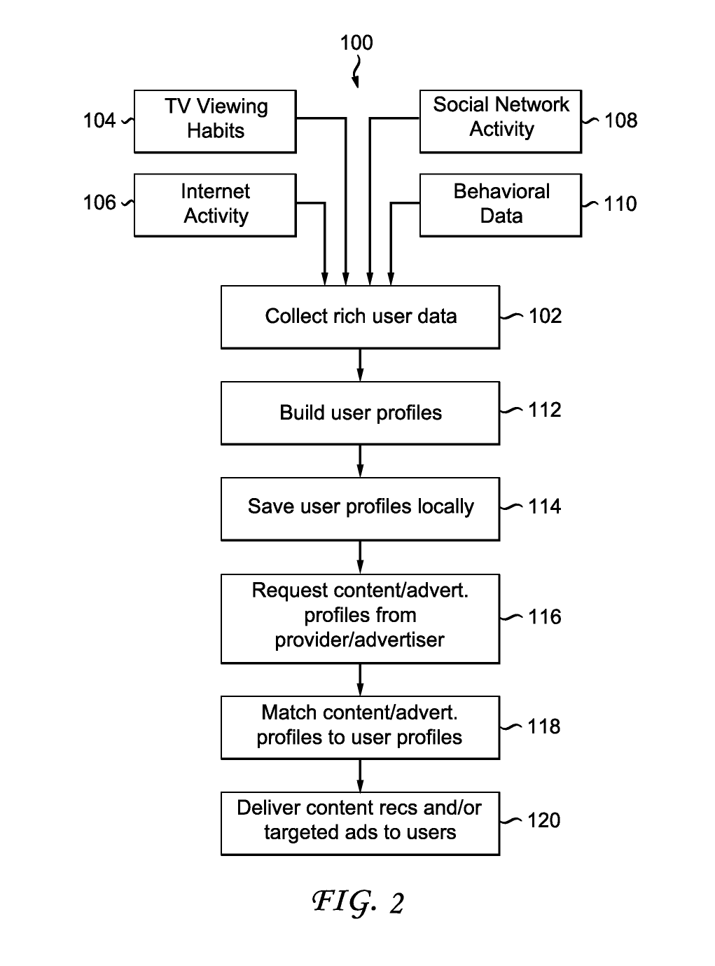

FIG. 2 shows a flow chart illustrating a method 100 of recommending content and targeting advertisements according to an embodiment. In one embodiment, the method 100 is performed by the aggregator 12 shown in FIG. 1. In other embodiments, the method 100 can be performed by other parts of the system 10, like, for example, the set top box 20 and/or the gateway 22. The aggregator 12 begins by collecting rich user data from the users 14, 16, 18 (step 102). Such rich user data can include a user's television viewing habits 104, such as what programs are watched and information about those programs, explicit user feedback about those programs (e.g. a “5-star” rating system), digital video recording operations performed during particular programs (e.g., play, pause, rewind and fast forward, jump back, scenes watched or skipped, actual time elapsed between start and end of program), advertisements skipped or viewed, and channel tuning and the like. Such rich user data can also come from a user's internet activity 106, which can be drawn from a user's gateway 22 and the like. The aggregator 12 can also draw social data 108 from a user's social network, which can include the user's own activity as well as that of the user's friends and connections, as well as behavioral data 110, such as laughing, screaming, and eye contact with the television, from cameras, microphones, and other sensing devices associated with the system.

After gathering such rich user data, the aggregator 12 builds a user profile (step 112) that serves as a description of the user's interests. This user profile can be updated regularly as the aggregator 12 obtains more rich user data during the course of its operation. The user profile can also be used with other user profiles to train content recommendation algorithms. Once they are built, the aggregator 12 stores the user profiles in a local memory (step 114). In one embodiment, once user profiles are stored locally, the aggregator 12 requests content profiles 32 and/or ad profiles 36 from the content provider 28 and/or advertiser 30, respectively (step 116). Upon receiving the content and/or ad profiles 32, 36, the aggregator 12 then matches them to the user profiles it deems most suitable for the content recommendations 34 and/or advertisements 38 contained in the content and ad profiles 32, 36 (step 118). The aggregator 12 then delivers the content recommendations 34 and/or targeted advertisements 38 to the users associated with the matched user profiles.

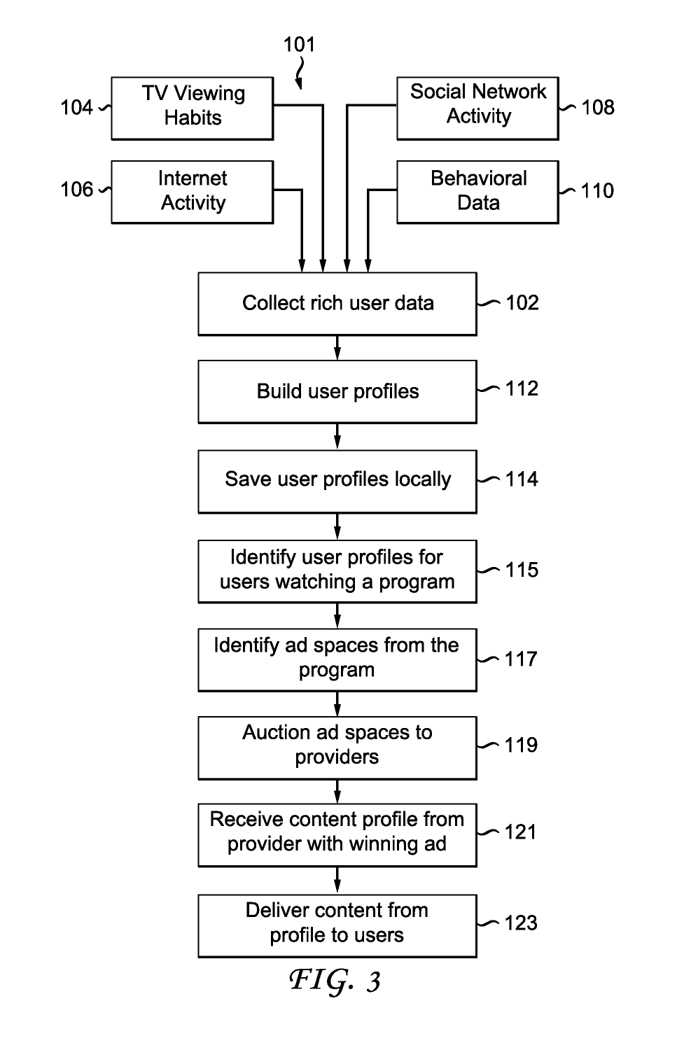

FIG. 3 shows a flow chart illustrating a method 101 of recommending content and targeting advertisements according to an embodiment. The embodiment shown in FIG. 3 is similar to the embodiment shown in FIG. 2 except where explicitly shown and discussed below. It should be noted that the steps identified in the method 101 can be performed as substitutes for certain steps identified in FIG. 2. Alternatively, the steps identified in the method 101 can be performed in addition to the steps identified in FIG. 2.

After the aggregator 12 has stored the user profiles in a local memory, the aggregator 12 identifies which user profiles are associated with a set of users watching a particular program (step 115). The aggregator then identifies the advertising spaces available during the particular program (step 117). Such advertising spaces can include commercial breaks, embedded video space present during the program, and in-program objects that can selectively display advertisements, such as a billboard at a live sporting event or a blank label of an object during a scripted show. The aggregator 12 then auctions the advertisement spaces associated with the particular program to advertisers based on the information contained in the user profiles (step 119). These advertisement auctions can auction the advertising space based on where and when they appear during a program. For example, certain advertisement spaces that appear earlier in the program can be auctioned at a higher price than advertisement spaces that appear later in the program. Alternatively, the advertisement auctions can be based on the location of the advertisement spaces in the watched program. When an auction is won, the aggregator receives a content and/or advertisement profile from the content provider and/or advertiser having the winning bid (step 121). The content profile is then delivered to the set of users watching the particular program (123).

In the embodiments discussed above, the user profiles are not accessible by content providers 28 and advertisers 30. This is done to allow the aggregator 12 to pick and choose what information it deems suitable for sharing with the content provider 28 and/or advertiser 30 for the purposes of selecting content recommendations or advertisements while maintaining the individual privacy of each user. In other embodiments, the user profiles are exchanged with the content provider 28 and/or advertiser 30 under a privacy-preserving protocol. In such a protocol, the user profile is transformed into a sanitized version of the user profile, which can then be shared with the content provider. The content provider then matches the sanitized user profile to a content profile and returns the content profile to the aggregator.

The various embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be understood that the embodiments described herein are merely exemplary and that a person skilled in the art may make many variations and modifications without departing from the spirit and scope of the invention. All such variations and modifications are intended to be included within the scope of the invention as defined in the appended claims.

1. A method of recommending content comprising:
collecting rich user data from at least one user, the rich user data including content viewing habits of a user;
building at least one user profile corresponding to a user, the user profile created using the rich user data associated with a respective user;
storing a user profile in a memory database;
requesting at least one content profile from at least one provider;
receiving a content profile;
determining whether one of the at least one user profile is a target user profile for one of the at least one content profile based on the rich user data associated with the target user profile; and
delivering at least one content program associated with the one of the at least one content profile to the user associated with the target user profile.

2. The method according to claim 1, wherein the content viewing habits of the rich user data includes at least one of television programs watched, digital video recording operations performed, advertisements viewed, advertisements skipped, and television channel changes.

3. The method according to claim 1, wherein the at least one provider is selected from a group consisting of advertisers and content providers.

4. The method according to claim 1, wherein the at least one user profile is not accessible by a provider.

5. The method according to claim 1, wherein requesting a content profile includes at least one of identifying advertising spaces associated with a program; auctioning the advertising spaces to a content provider; and receiving a content profile from a content provider having a winning bid.

6. A method of recommending content comprising:
collecting rich user data from at least one user, the rich user data including content viewing habits of a user;
building at least one user profile corresponding to a user, the user profile created using the rich user data associated with a respective user;
storing a user profile in a memory database;
identifying at least one target user profile from a user profile, the target user profile associated with a content-based program;
identifying an advertising space associated with a content-based program;
auctioning an advertising space to at least one content provider;
receiving a content profile from a content provider having a winning bid; and
delivering at least one content program associated with a content profile to a user associated with a target user profile.

7. The method according to claim 6, wherein the content viewing habits of the rich user data includes at least one of television programs watched, digital video recording operations performed, advertisements viewed, advertisements skipped, and television channel changes.

8. The method according to claim 6, wherein a provider is selected from a group consisting of advertisers and content providers.

9. The method according to claim 6, wherein a user profile is not accessible by a provider.

10. A content recommendation system, comprising:
a memory database for storing a plurality of user profiles; and
an aggregator connected to one or more users, the aggregator configured to
collect rich user data from at least one user, the rich user data including content viewing habits of a user;
build at least one user profile corresponding to a user, the user profile created using the rich user data associated with a respective user;
store a user profile in the memory database;
request at least one content profile from a provider, the provider selected from a group consisting of content providers and advertisers;
receive a content profile;
determine whether a user profile is a target user profile for a content profile based on the rich user data associated with the target user profile; and
deliver at least one content program associated with a content profile to a user associated with a target user profile.

11. The system according to claim 10, wherein a content viewing habit of rich user data includes at least one of television programs watched, digital video recording operations performed, advertisements viewed, advertisements skipped, and television channel changes.

12. The system according to claim 10, wherein a provider is selected from a group consisting of advertisers and content providers.

13. The system according to claim 10, wherein a user profile is not accessible by a provider.

14. The system according to claim 10, wherein the aggregator is further configured to
identify at least one advertising space associated with a program;
auction an advertising space to a content provider; and
receive a content profile from a content provider having a winning bid.

15. A content recommendation system comprising:
a memory database for storing a plurality of user profiles; and
an aggregator connected to at least one user, the aggregator configured to
collect rich user data from a user, the rich user data including a content viewing habit of a user;
build at least one user profile corresponding to a user, the user profile created using the rich user data associated with a respective user;
store a user profile in the memory database;
transform a user profile into at least one sanitized user profile;
transmit a sanitized user profile to at least one provider for matching with at least one content profile, a provider selected from a group consisting of content providers and advertisers;
receive a content profile from a provider; and
deliver at least one content program associated with a content profile to a user associated with a sanitized user profile.
